(19) United States
(12) Patent Application Publication
(10) Pub. No.: US 2022/0277195 A1
(43) Pub. Date: Sep. 1, 2022

(54) AUTOMATED DATA AUGMENTATION IN DEEP LEARNING

(71) Applicant: GE Precision Healthcare LLC, Waukesha, WI (US)

(72) Inventors: Xiaomeng Dong, Norman, OK (US); Michael Potter, Concord, CA (US); Venkata Ratnam Saripalli, Danville, CA (US)

(21) Appl. No.: 17/648,996

(22) Filed: Jan. 26, 2022

Related U.S. Application Data
(60) Provisional application No. 63/154,033, filed on Feb. 26, 2021.

(51) Int. Cl. G06N 3/08

(52) U.S. Cl. CPC G06N 3/08

(57) ABSTRACT

Techniques regarding autonomous data augmentation are provided. For example, one or more embodiments described herein can regard a system comprising a memory that can store computer-executable components. The system can also comprise a processor, operably coupled to the memory, that executes the computer-executable components stored in the memory. The computer-executable components can include a data augmentation component that executes a random unidimensional augmentation algorithm to augment a dataset for training a machine learning model via a plurality of augmentation operations. The random unidimensional augmentation algorithm can employ a global augmentation parameter that defines: a distortion magnitude associated with the plurality of augmentation operations, and a number of augmentation operations included in the plurality of augmentation operations.

### CROSS-REFERENCE TO RELATED APPLICATIONS

This application claims the benefit of and priority to U.S. Provisional Application No. 63/154,033 entitled “AUTOMATED DATA AUGMENTATION IN DEEP LEARNING” and filed on Feb. 26, 2021. The entirety of the aforementioned application is hereby incorporated herein by reference.

### TECHNICAL FIELD

The subject disclosure relates to one or more computer-implemented methods and/or systems for autonomous data augmentation to facilitate deep learning models, and more specifically, to random unidimensional data augmentation that can improve machine learning model performance with minimal computational resources.

### BACKGROUND

Data augmentation is used to improve deep-learning model performance metrics without incurring additional computational costs at inferencing time. Unfortunately, creating a data augmentation strategy typically requires human expertise and/or domain knowledge, which is inconvenient during initial development as well as when transferring existing strategies between different tasks. To overcome these drawbacks, attempts have been made to automate the data augmentation process.

Typical automated data augmentation processes employ augmentation parameters that are jointly optimized alongside the neural network parameters during training, which can introduce massive search spaces, and in turn can significantly increase the time required to train a model. For example, one or more automated augmentation policies have employed reinforcement learning (“RL”) on a search space of size 10³², which can cost thousands of graphic processor unit (“GPU”) hours to find a solution for a single task. Additionally, automated augmentation policies can be undesirable due to the complexity of implementing joint optimization algorithms.

An example typical augmentation policy is RandAugment, which is an automated augmentation policy developed to address the large search space issue. RandAugment removes the policy optimization employed by other techniques. For example, RandAugment can reduce the search space from 10³² to 10². However, RandAugment can require as many as 100 full model training iterations to settle on an ideal configuration. The computational cost of performing so many training tasks can often be prohibitive. To overcome the computational cost, human expertise is often employed with RandAugment to pre-select a sub-grid for the search, which severely limits the practicality of the approach as an autonomous solution.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can regard automated data augmentation processes that employ random unidimensional augmentation algorithm are described.

According to an embodiment, a system is provided. The system can comprise a processor, operably coupled to the memory, that executes the computer-executable components stored in the memory. The computer-executable components can include a data augmentation component that can execute a random unidimensional augmentation algorithm to augment a dataset for training a machine learning model via a plurality of augmentation operations. The random unidimensional augmentation algorithm can employ a global augmentation parameter that defines: a distortion magnitude associated with the plurality of augmentation operations, and a number of augmentation operations included in the plurality of augmentation operations.

According to another embodiment, a computer-implemented method is provided. The computer-implemented method can comprise executing, by a system operably coupled to a processor, a random unidimensional augmentation algorithm to augment a dataset for training a machine learning model via a plurality of augmentation operations. The random unidimensional augmentation algorithm can employ a global augmentation parameter that defines: a distortion magnitude associated with the plurality of augmentation operations, and a number of augmentation operations included in the plurality of augmentation operations.

According to another embodiment, a computer program product for data augmentation is provided. The computer program product can comprise a computer readable storage medium having program instructions embodied therewith. The program instructions can be executable by a processor to cause the processor to execute, by the processor, a random unidimensional augmentation algorithm to augment a dataset for training a machine learning model via a plurality of augmentation operations. The random unidimensional augmentation algorithm can employ a global augmentation parameter that defines: a distortion magnitude associated with the plurality of augmentation operations, and a number of augmentation operations included in the plurality of augmentation operations.

### BRIEF DESCRIPTION OF THE DRAWINGS

FIG. 1 illustrates a block diagram of an example, non-limiting system that can generate a one-dimensional search space that can be employed via an autonomous random unidimensional data augmentation for training one or more machine learning models in accordance with one or more embodiments described herein.

FIG. 2 illustrates diagrams of example, non-limiting graphs that can depict machine learning model accuracy as function of two global parameters in accordance with one or more embodiments described herein.

FIG. 3 illustrates a diagram of an example, non-limiting graph that can depict preprocessing and training speeds as a function of an augmentation parameter in accordance with one or more embodiments described herein.

FIG. 4 illustrates a diagram of an example, non-limiting system that can generate one or more transition operations that can be employed via an autonomous random unidimensional data augmentation for training one or more machine learning models in accordance with one or more embodiments described herein.

FIG. 5 illustrates a diagram of an example, non-limiting table that can exemplify one or more transition operations that can be generated for employment via an autonomous random unidimensional data augmentation for training one or more machine learning models in accordance with one or more embodiments described herein.

FIG. 6 illustrates a diagram of an example, non-limiting system that can execute an automated search algorithm employed via an autonomous random unidimensional data augmentation for training one or more machine learning models in accordance with one or more embodiments described herein.

FIGS. 7-8 illustrate diagrams of example, non-limiting graphs that can demonstrate a unimodal relation that characterizes one or more machine learning models in accordance with one or more embodiments described herein.

FIG. 9 illustrates a diagram of an example, non-limiting pseudo code that can characterize one or more automated search algorithms that can be employed via an autonomous random unidimensional data augmentation for training one or more machine learning models in accordance with one or more embodiments described herein.

FIG. 10 illustrates a diagram of an example, non-limiting table that can demonstrate the efficacy of generating one or more transition operations employed via an autonomous random unidimensional data augmentation for training one or more machine learning models in accordance with one or more embodiments described herein.

FIG. 11 illustrates a diagram of example, non-limiting tables that can demonstrate the efficacy of one or more autonomous random unidimensional data augmentations for training one or more machine learning models in accordance with one or more embodiments described herein.

FIG. 12 illustrates a flow diagram of an example, non-limiting computer-implemented method that can employ one or more autonomous random unidimensional data augmentations for training one or more machine learning models in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Given the problems with other implementations of training dataset augmentation; the present disclosure can be implemented to produce a solution to one or more of these problems by utilizing a single global augmentation parameter that can enable generation of a unidimensional search space. Advantageously, one or more embodiments described herein can execute one or more autonomous search algorithms in conjunction with the reduced search space to negate a need for human intervention (e.g., negate a need for a subject matter expert to define a relevant sub-grid of the search space) and reduce computation resources.

Various embodiments of the present invention can be directed to computer processing systems, computer-implemented methods, apparatus and/or computer program products that facilitate the efficient, effective, and autonomous (e.g., without direct human guidance) data augmentation for improving deep-learning model performance. For example, one or more embodiments described herein can employ a random unidimensional augmentation (“RUA”) process to employ a plurality of augmentation operations that directly correlate to a single global augmentation parameter. Also, one or more embodiments described herein can constitute a technical improvement over conventional training dataset augmentation by reducing the training data search space to a size of 10¹, increasing the diversity of transformation domains, and/or relieving human expertise requirements via efficient, autonomous search algorithms. Further, one or more embodiments described herein can have a practical application by improving the performance of a machine learning model. For instance, various embodiments described herein can control the composition of the model's training dataset, thereby affecting one or more model performance metrics independent typical computational costs at inferencing time.

As used herein, the term “machine learning task” can refer to an application of artificial intelligence (“AI”) technologies to automatically and/or autonomously learn and/or improve from an experience (e.g., training data) without explicit programming of the lesson learned and/or improved. For example, machine learning tasks can utilize one or more algorithms to facilitate supervised and/or unsupervised learning to perform tasks such as classification, regression, and/or clustering. Execution of a machine learning task can be facilitated by one or more machine learning models trained on one or more datasets in accordance with one or more model configuration settings.

As used herein, the term “machine learning model” can refer to a computer model that can be used to facilitate one or more machine learning tasks. For example, the computer model can simulate a number of interconnected processing units that can resemble abstract versions of neurons. For instance, the processing units can be arranged in a plurality of layers (e.g., one or more input layers, one or more hidden layers, and/or one or more output layers) connected with by varying connection strengths (e.g., which can be commonly referred to within the art as “weights”). Machine learning can learn through training, where data with known outcomes is inputted into the computer model, outputs regarding the data are compared to the known outcomes, and/or the weights of the computer model are autonomous adjusted based on the comparison to replicate the known outcomes. As used herein, the term “training dataset” can refer to data and/or data sets used to train one or more neural network models. As a machine learning model trains (e.g., utilizes more of a training dataset), the machine learning model can become increasingly accurate; thus, trained machine learning models can accurately analyze data with unknown outcomes, based on lessons learning from training data, to facilitate one or more machine learning tasks. Example machine learning models can include, but are not limited to: perceptron (“P”), feed forward (“FF”), radial basis network (“RBF”), deep feed forward (“DFF”), recurrent neural network (“RNN”), long/short term memory (“LSTM”), gated recurrent unit (“GRU”), auto encoder (“AE”), variational AE (“VAE”), denoising AE (“DAE”), sparse AE (“SAE”), markov chain (“MC”), Hopfield network (“HN”), Boltzmann machine (“BM”), deep belief network (“DBN”), deep convolutional network (“DCN”), deconvolutional network (“DN”), deep convolutional inverse graphics network (“DCIGN”), generative adversarial network (“GAN”), liquid state machine (“LSM”), extreme learning machine (“ELM”), echo state network (“ESN”), deep residual network (“DRN”), kohonen network (“KN”), support vector machine (“SVM”), and/or neural turing machine (“NTM”).

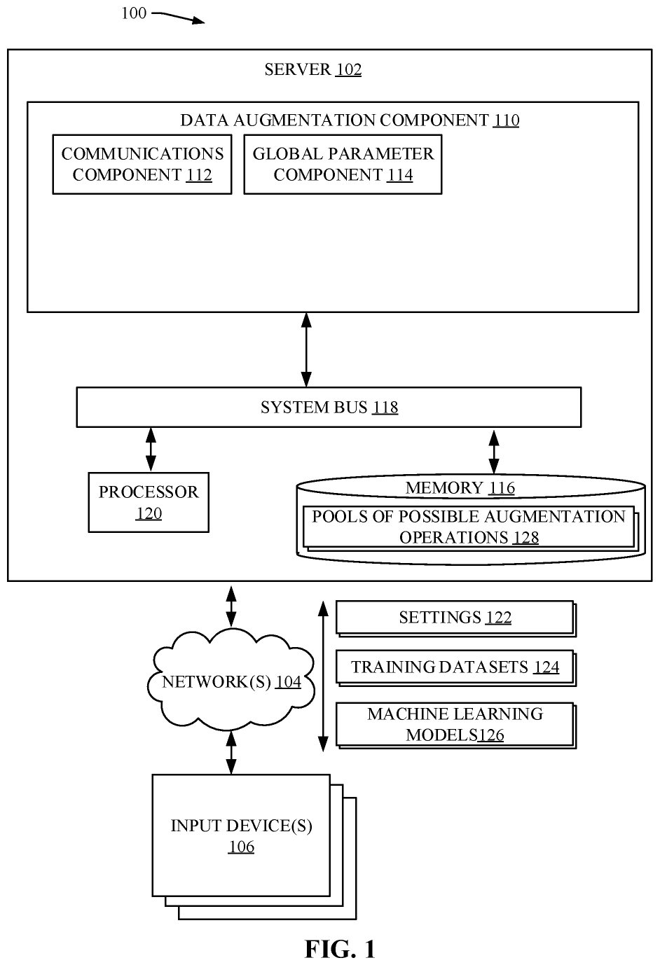

FIG. 1 illustrates a block diagram of an example, non-limiting system 100 that can autonomously augment one or more training datasets for one or more machine learning models. Repetitive description of like elements employed in other embodiments described herein is omitted for sake of brevity. Aspects of systems (e.g., system 100 and the like), apparatuses or processes in various embodiments of the present invention can constitute one or more machine-executable components embodied within one or more machines, e.g., embodied in one or more computer readable mediums (or media) associated with one or more machines. Such components, when executed by the one or more machines (e.g., computers, computing devices, virtual machines, a combination thereof, and/or the like) can cause the machines to perform the operations described.

As shown in FIG. 1, the system 100 can comprise one or more servers 102, networks 104, and/or input devices 106. The server 102 can comprise data augmentation component 110. The data augmentation component 110 can further comprise communications component 112 and/or global parameter component 114. Also, the server 102 can comprise or otherwise be associated with at least one memory 116. The server 102 can further comprise a system bus 118 that can couple to various components such as, but not limited to, the data augmentation component 110 and associated components, memory 116 and/or a processor 120. While a server 102 is illustrated in FIG. 1, in other embodiments, multiple devices of various types can be associated with or comprise the features shown in FIG. 1. Further, the server 102 can communicate with one or more cloud computing environments.

The one or more networks 104 can comprise wired and wireless networks, including, but not limited to, a cellular network, a wide area network (WAN) (e.g., the Internet) or a local area network (LAN). For example, the server 102 can communicate with the one or more input devices 106 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the embodiment shown the data augmentation component 110 can be provided on the one or more servers 102, it should be appreciated that the architecture of system 100 is not so limited. For example, the data augmentation component 110, or one or more components of data augmentation component 110, can be located at another computer device, such as another server device, a client device, and/or the like.

The one or more input devices 106 can comprise one or more computerized devices, which can include, but are not limited to: personal computers, desktop computers, laptop computers, cellular telephones (e.g., smart phones), computerized tablets (e.g., comprising a processor), smart watches, keyboards, touch screens, mice, a combination thereof, and/or the like. In various embodiments, the one or more input devices 106 can be employed to enter one or more settings 122 (e.g., which can define one or more augmentation operations, a global augmentation parameter, and/or machine learning tasks in accordance with various embodiments described herein), training datasets 124, and/or machine learning models 126 into the system 100, thereby sharing (e.g., via a direct connection and/or via the one or more networks 104) said data with the server 102. For example, the one or more input devices 106 can send data to the communications component 112 (e.g., via a direct connection and/or via the one or more networks 104). Additionally, the one or more input devices 106 can comprise one or more displays that can present one or more outputs generated by the system 100 to a user. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

In various embodiments, the one or more input devices 106 and/or the one or more networks 104 can be employed to input one or more settings 122 and/or commands into the system 100. For example, in the various embodiments described herein, the one or more input devices 106 can be employed to operate and/or manipulate the server 102 and/or associate components. Additionally, the one or more input devices 106 can be employed to display one or more outputs (e.g., displays, data, visualizations, and/or the like) generated by the server 102 and/or associate components. Further, in one or more embodiments, the one or more input devices 106 can be comprised within, and/or operably coupled to, a cloud computing environment. In various embodiments, the one or more input devices 106 can be employed to enter one or more training datasets 124 into the system 100 for augmentation by the data augmentation component 110. The augmented training dataset 124 can thereby be utilized to train one or more machine learning models 126. In various embodiments, the augmentation component can share the one or more augmented training datasets 124 with the one or more input devices 106 and/or directly supply the one or more augmented training datasets 124 to the one or more machine learning models 126 to facilitate training.

In one or more embodiments, the data augmentation component 110 can execute an RUA algorithm to augment the one or more training datasets 124 utilized to train a machine learning model 126. In accordance with various embodiments described herein, the one or more training datasets 124 can be supplied via the one or more input devices 106. Alternatively, or additionally, one or more of the training datasets 124 can be retrieved from one or more memories 116 of the system 100. For instance, the data augmentation component 110 (e.g., via the communications component 112) can retrieve one or more training datasets 124 from one or more memories 116 serving as dataset repositories.

In various embodiments, the RUA algorithm can execute one or more augmentation operations on the one or more training datasets 124. For example, the data augmentation component 110 can select augmentation operations to be employed by the RUA algorithm from a pool of possible augmentation operations 128. In one or more embodiments, the one or more machine learning models 126 can be trained via a plurality of training steps. With each training step, the data augmentation component 110 can augment the one or more training datasets 124 to generate one or more new augmented training datasets 124. Thus, each training step can be associated with a respective selection of augmentation operations by the data augmentation component 110. In various embodiments, the data augmentation component 110 can select the augmentation operations randomly (e.g., via uniform probability, with replacement).

As shown in FIG. 1, the pool of possible augmentation operations 128 can be stored in the one or more memories 116. In various embodiments, one or more augmentation operations included in the pool of possible augmentation operations 128 can be provided as one or more settings 122 entered into the system via the one or more input devices 106. Additionally, one or more augmentation operations included in the pool of possible augmentation operations 128 can be predefined and/or can be operations utilized by the data augmentation component 110 in previous training dataset 124 augmentations. In various embodiments, the composition of the pool of possible augmentation operations 128 can depend on one or more characteristics of the one or more training datasets 124. For example, the composition of the pool of possible augmentation operations 128 can depend on the type of data, amount of data, and/or size of data included in the one or more training datasets 124. In one or more embodiments, the training datasets 124 can be associated with respective pools of possible augmentation operations 128. Example augmentation operations that can be included in the one or more pools of possible augmentation operations 128 can include, but are not limited to: a contrast adjustment operation, a histogram equalization operation, a rotate operation, a solarize operation, a posterize operation, a color adjustment operation, a brightness adjustment operation, a sharpness adjustment operation, one or more shear operations (e.g., with respect to the X and/or Y axes), one or more translate operations (e.g., with respect to the X and/or Y axes), zoom operations, a de-harmonization operation, a blur operation, noise addition, grid distortion, a combination thereof, and/or the like.

In one or more embodiments, the global parameter component 114 can define a global augmentation parameter (“P”) employed by the RUA algorithm. In various embodiments, the RUA algorithm can employ a single global augmentation parameter P to affect each of the augmentation operations included in the one or more pool of possible augmentation operations 128. For example, the global parameter component 114 can set a single global augmentation parameter P to encompass a plurality of parameters including, but not limited to: a distortion magnitude parameter; a number of augmentation operations parameter, probability of application, a combination thereof, and/or the like. For instance, the single global augmentation parameter P can define: how many augmentation operations are to be selected from the one or more pools of possible augmentation operations 128 for a given iteration of training; and/or a distortion magnitude (e.g., which can control an amount of augmentation resulting from implementing respective augmentation operations). In one or more embodiments, the global parameter component 114 can query the one or more input devices 106 to define the global augmentation parameter P. In one or more embodiments, the global parameter component 114 can set the global augmentation parameter P in accordance with one or more predefined values. In one or more embodiments, the global augmentation parameter P can be within a predefined integer range (e.g., from 1-10, or higher). In one or more embodiments, the global parameter component 114 define the global augmentation parameter P based on a plurality of parameter values defined in one or more settings 122 provided via the one or more input devices 106 (e.g., the global augmentation parameter can be function of multiple parameter values, such as a weighted average).

In various embodiments, the data augmentation component 110 can execute the RUA algorithm over multiple training iterations. With each training iteration, the data augmentation component 110 can select a different value for the global augmentation parameter P from the unidimensional search space. Additionally, with each training iteration, the data augmentation component 110 (e.g., and/or one or more associate components thereof in accordance with various embodiments described herein) can measure the performance of the machine learning model 126 with respect to one or more performance metrics (e.g., accuracy, precision, computational resources utilized, speed, a combination thereof and/or the like). By exploring the possible P values through the plurality of training iterations, the data augmentation component 110 can determine an optimal value for the global augmentation parameter P. Thus, by reducing the search space to a unidimensional space, the data augmentation component 110 can determine the optimal P value with few training iterations and minimal computation resources.

In contrast, typical data augmentation policies (e.g., such as RandAugment) perform augmentation operations based on a multitude of global parameters. As the number of global parameters increases, the resulting search space also increases. For instance, accounting for the distortion magnitude (e.g., parameter “M”) and the number of augmentation operations (e.g., parameter “N”) as separate global parameters (e.g., rather than as a single global augmentation parameter in accordance with various embodiments described herein) can result in a search space of size 10² (e.g., an order of magnitude larger that the unidimensional search space that can be achieved in accordance with various embodiments described herein).

Further, as the size of the search space increases, the number of training iterations required to determine optimal augmentation settings can also increase. For instance, the search space of size 10² exemplified above can result in a 10×10 grid search, which can require repeating the training 100 times to find the best augmentation settings. To avoid the computational costs associated with the 100 training iterations, a sub-grid is typically selected before performing the search. However, appropriate sub-grid selection is highly dependent on the networks and/or datasets involved, thereby re-introducing a need for human expertise and/or experience.

By defining a single global augmentation parameter to be employed by the one or more RUA algorithms, the global parameter component 114 can reduce the dimensionality of the search space (e.g., as compared to typical augmentation protocols, which may employ multiple global parameters). Thereby, the data augmentation component 110 can reduce the search space, optimize the augmentation parameters, and employ one or more efficient search algorithms to negate human intervention while minimizing computational resources in accordance with various embodiments described herein.

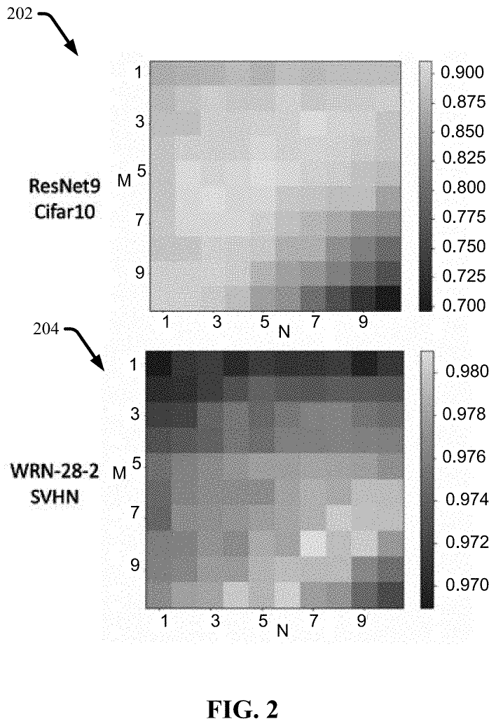

FIG. 2 illustrates a diagram of example, non-limiting graphs 202, 204 that can demonstrate the efficacy of employing a single global augmentation parameter P (e.g., via global parameter component 114) in accordance with one or more embodiments described herein. Repetitive description of like elements employed in other embodiments described herein is omitted for sake of brevity. To establish graphs 302 and/or 304, the RandAugment algorithm was executed on a full 10×10 grid for two machine learning tasks (e.g., classification tasks) using the machine learning models 126 ResNet9 and WRN-28-2 on the training datasets 124 Cifar10 and/or SVHN. Graphs 202 and/or 204 depict model accuracy as a function of two global parameters (e.g., processed as separate parameters): the distortion magnitude parameter M, and the number of augmentation operations N.

As shown in FIG. 2, the greyscale gradients in graphs 202 and/or 204 form a diagonal from the top left of the graphs 202 and/or 204 to the bottom right of the graphs 202 and/or 204. Although the accuracy values and/or optimal points vary between graph 202 and 204, both exhibit an approximately diagonal gradient. The existence of the diagonal gradient demonstrates that the two global parameters can be merged (e.g., via the global parameter component 114) to reduce the search space along the diagonal gradient while still capturing the accuracy of the model configurations. In various embodiments, the global parameter component 114 can merge multiple parameters by a linear combination to form the global augmentation parameter P. Additionally, the coefficients for the linear combination can be adjusted to account for computational resources and/or machine learning model 126 performance.

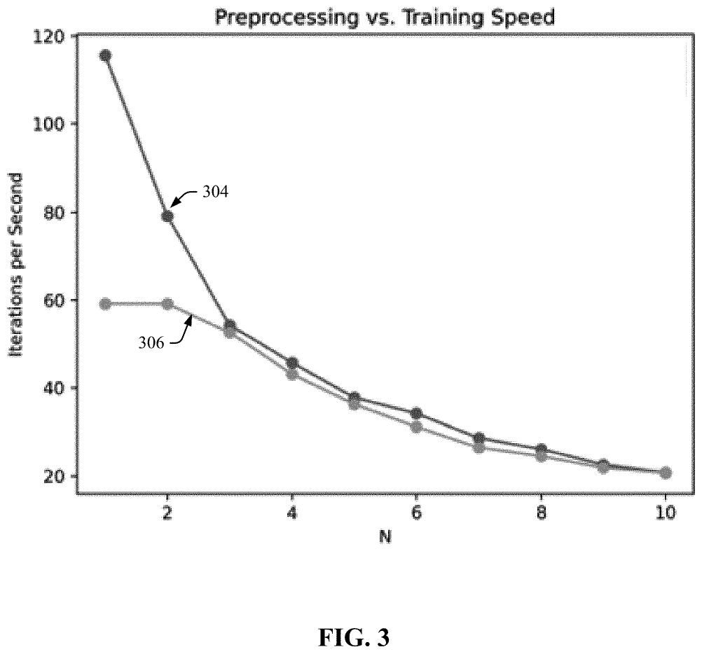

FIG. 3 illustrates a diagram of an example, non-limiting graph 302 that can demonstrate preprocessing and training speed as a function of training iterations in accordance with one or more embodiments described herein. Repetitive description of like elements employed in other embodiments described herein is omitted for sake of brevity. In various embodiments, the parameters encompassed by the global augmentation parameter P can have varying degrees of affect on one or more performance metrics of the one or more machine learning models 126. Thus, the global parameter component 114 can define the global augmentation parameter P such that the value of the global augmentation parameter P can translate to respective values (e.g., different values) of the encompassed parameters.

For instance, FIG. 3 demonstrates that where the global augmentation parameter P encompasses distortion magnitude M and the number of augmentation operations N, adjustments to the number of augmentation operations N can have a greater affect on preprocessing and training speed of the machine learning model 126 than distortion magnitude M adjustments. To establish graph 302, data augmentation was employed using the two global parameters M and N on the machine learning model 126 ResNet9 with training dataset 124 Cifar10. Line 304 represents the preprocessing speed, and line 306 represents the training speed.

As shown in FIG. 3, applying a large number of augmentations during training can severely bottleneck the training speed. For instance, graph 302 exemplifies that where the number of augmentation operations N is greater than or equal to 3 (e.g., N≥3), the central processor unit (“CPU”)-based pre-processing can become rate limiting (e.g., especially where N≥5). In various embodiments, the global parameter component 114 can define the global augmentation parameter P such that the maximum number of augmentation operations is capped at 5 based on the preprocessing and training speed relations depicted in FIG. 3. For instance, the global parameter component 114 can set the number of augmentation operations in relation to the global augmentation parameter P in accordance with Equation 1 below.

$$N = ceil ( \frac{5 P}{{P}_{max}} ) \qquad ( 1 )$$

In various embodiments, the maximum number of augmentation operations can be set to a value greater than five in defining the global augmentation parameter P. For instance, the global parameter component 114 can define the global augmentation parameter P based on the computational resources available to train the one or more machine learning models 126 (e.g., which can be included in the one or more settings 122 defined by the one or more input devices 106).

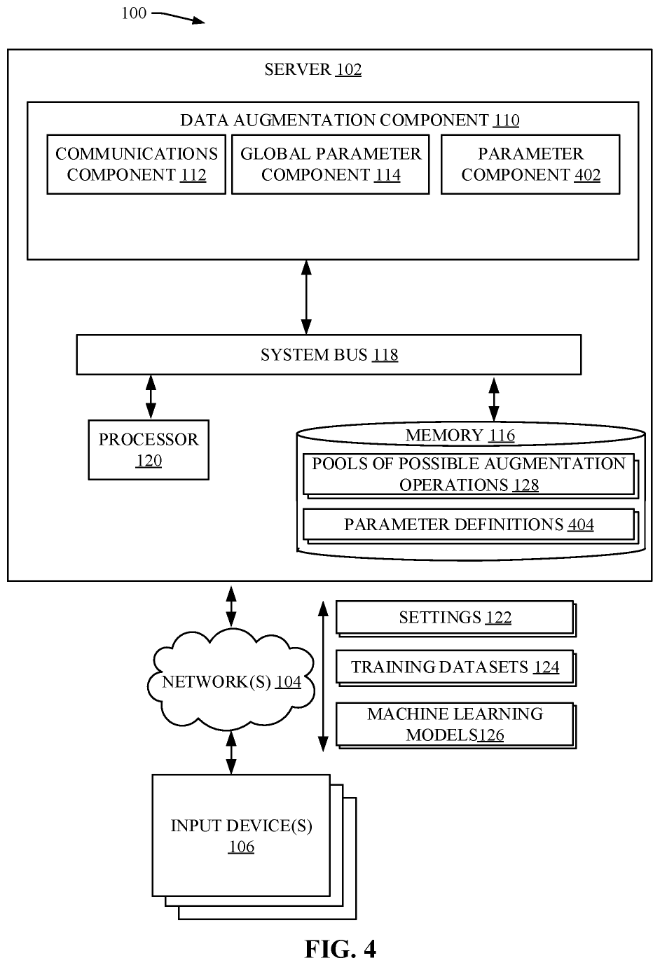

FIG. 4 illustrates a diagram of the example, non-limiting system 100 further comprising parameter component 402 in accordance with one or more embodiments described herein. Repetitive description of like elements employed in other embodiments described herein is omitted for sake of brevity. In one or more embodiments, the parameter component 402 can generate parameter definitions 404 for the augmentation operations included in the one or more pools of possible augmentation operations 128. For example, the parameter component 402 can generate parameter definitions 404 that align (e.g., directly correlate) the one or more augmentation operations with the global augmentation parameter P. As shown in FIG. 4, the one or more parameter definitions 404 can be stored in the one or more memories 116 for subsequent retrieval by the data augmentation component 110 and/or associate components thereof.

In various embodiments, utilizing a single global augmentation parameter P can reduce the search space to a unidimensional space. Further, the global augmentation parameter P can control the augmentation intensity (e.g., the amount of augmentation) associated with one or more of the augmentation operations via a direct correlation. For instance, a zero value of the global augmentation parameter P can result in no augmentation, whereas increasing the value of the global augmentation parameter P can result in increasing amounts of augmentation. The parameter component 402 can generate parameter definitions 404 associated with respective augmentation operations such that P=0 results in no augmentation. Additionally, the parameter component 402 can define the maximum augmentation intensity for one or more augmentation operations. Further, in one or more embodiments, the parameter component 402 can employ random uniform distributions (“U”) into the parameter definitions 404 of the augmentation operations to control the density of the search space (e.g., with respect to the augmentation operations).

In one or more embodiments, the one or more input devices 106 can be employed to enter one or more augmentation operations and/or associate definitions into the system 100. Further, the parameter component 402 can check whether the provided definition is aligned with the global augmentation parameter P. For example, the parameter component 402 can determine whether an increase in the value of the global augmentation parameter P would also result in an increase in augmentation achieved by the given augmentation operation in accordance with the given definition. Where an increase in the value of the global augmentation parameter P can result in a decrease in the amount of augmentation achieved by the augmentation operation, the parameter component 402 can determine that the given definition is unaligned with the global augmentation parameter P. For instance, the given definition can define the augmentation operation as an inverse of a parameter encompassed by the global augmentation parameter P. Where a given definition is unaligned with the global augmentation parameter P, the parameter component 402 can adjust the given parameter to generate a parameter definition 404 associated with the given augmentation operation that is aligned with the global augmentation parameter P. For example, the parameter component 402 can transform the inverse correlation in the given definition into a direct correlation in the parameter definition 404. Additionally, the parameter component 402 can generate one or more parameter definitions 404 that align off-centered correlations of given definition into centered linear correlations.

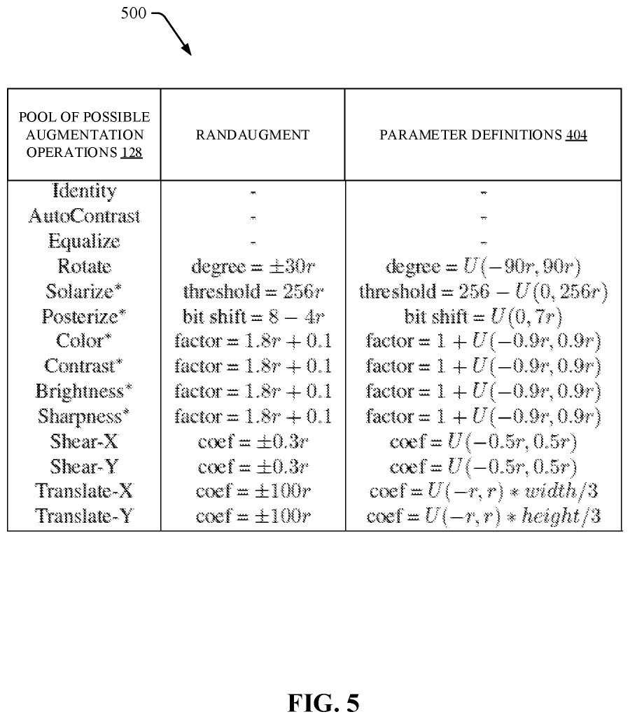

FIG. 5 illustrates a diagram of an example, non-limiting table 500 that can demonstrate exemplary parameter definitions 404 that can be generated by the parameter component 402 in accordance with one or more embodiments described herein. Repetitive description of like elements employed in other embodiments described herein is omitted for sake of brevity. Table 500 can depict exemplary parameter definitions 404 in association with augmentation operations of an exemplary pool of possible augmentation operations 128, which the data augmentation component 110 can select from. Further, table 500 can depict example parameter definitions 404 that can be generated by the parameter component 402 in comparison to definitions utilized by a typical augmentation policies (e.g., RandAugment). In FIG. 5, r=M/Mₘₐₓ for RandAugment, and r=P/Pₘₐₓ for the parameter definitions 404 generated by the parameter component 402. Augmentation operations marked with a star (“*”) can have a non-zero impact at r=0 under RandAugment (e.g., can be unaligned with the global augmentation parameter P), but are zero-aligned in accordance with the parameter definition 404 generated by the parameter component 402 and/or thereby utilized in the one or more RUA algorithms.

While table 500 depicts 14 example augmentation operations and association definitions (e.g., parameter definitions 404), the architecture of the RUA algorithm is not so limited. For example, embodiments in which the size of the pool of possible augmentation operations 128, and/or associate parameter definitions 404, is greater than or less than 14 are also envisaged. For instance, in one or more embodiments the parameter component 502 can generate parameter definitions 404 for additional augmentation operations, including, but not limited to: zooming, de-harmonization, blur, a combination thereof, and/or the like.

As shown in FIG. 5, augmentation operations of typical augmentation policies (e.g., RandAugment) cannot scale with a single global parameter (e.g., thereby cannot be employed with a one-dimensional search space, such as the space established by the global parameter component 114). For example, the augmentation intensity of the solarize augmentation operation and posterize augmentation operation shown in FIG. 5 are inversely correlated with parameter M of RandAugment. Moreover, the color augmentation operation, contrast augmentation operation, brightness augmentation operation, and/or sharpness augmentation operation exemplified in FIG. 5 are shifted in that they cause no augmentation when

$$\frac{M}{{M}_{max}} = 1 ,$$

whereas values closer to 0 or greater than 1 lead to stronger alterations to the input.

Additionally, typical augmentation policies (e.g., RandAugment) use deterministic augmentations for any given global parameter M. For example, when M=Mₘₐₓ, the images will rotate ±30 degrees whenever the rotate augmentation operation is applied. The deterministic behavior significantly reduces diversity in the augmentation space and could therefore allow machine learning models 126 to over-fit more easily. In contrast, the parameter component 402 can generate parameter definitions such that P=0 will result in no augmentation. Further, the maximum degree of rotation can be extended by the parameter component 402 from ±30 degrees to ±90 degrees.

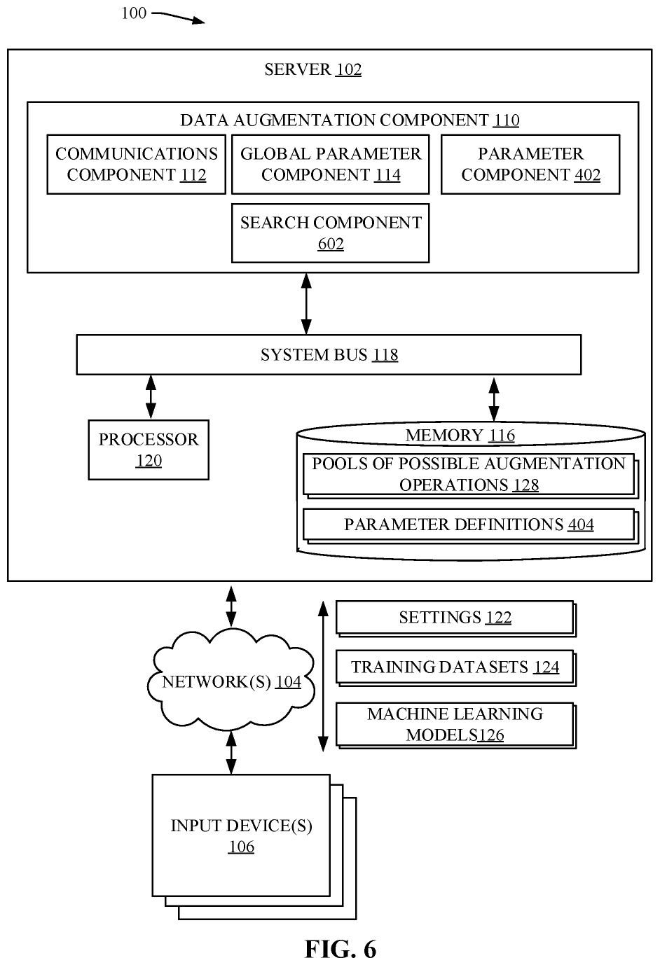

FIG. 6 illustrates a diagram of the example, non-limiting system 100 further comprising search component 602 in accordance with one or more embodiments described herein. Repetitive description of like elements employed in other embodiments described herein is omitted for sake of brevity. In various embodiments, the search component 602 can employ one or more search algorithms that are more efficient than grid searches to explore the search space with minimal computational resources.

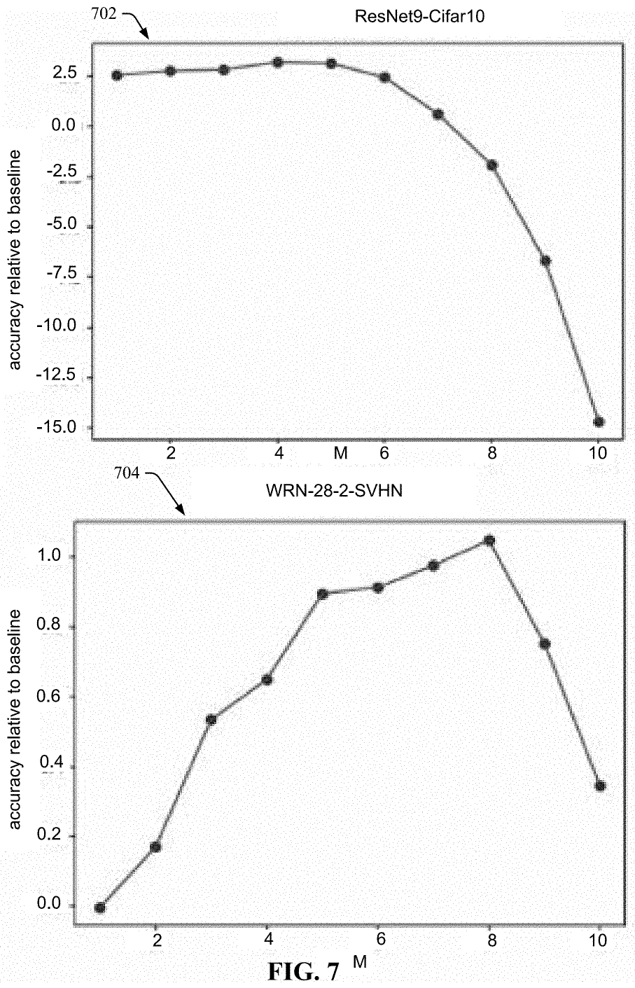

Graphs 202 and/or 204 further illustrate that while traversing the diagonal gradients, accuracy of the machine learning models 126 can first increase to a maximum and then decrease. Thereby, the machine learning model 126 can experience unimodality with respect to a given parameter, such as the distortion magnitude parameter M. FIG. 7 illustrates a diagram of example, non-limiting graphs 702 and/or 704 that can exemplify the unimodality of one or more machine learning model 126 in accordance with one or more embodiments described herein. Repetitive description of like elements employed in other embodiments described herein is omitted for sake of brevity. To establish graphs 702 and/or 704, the diagonal terms from graphs 202 and/or 204 were extracted and the associate relative accuracies were plotted against the parameter M. Thereby, graph 702 can depict the unimodality inherent to graph 202, and graph 704 can depict the unimodality inherent to graph 204.

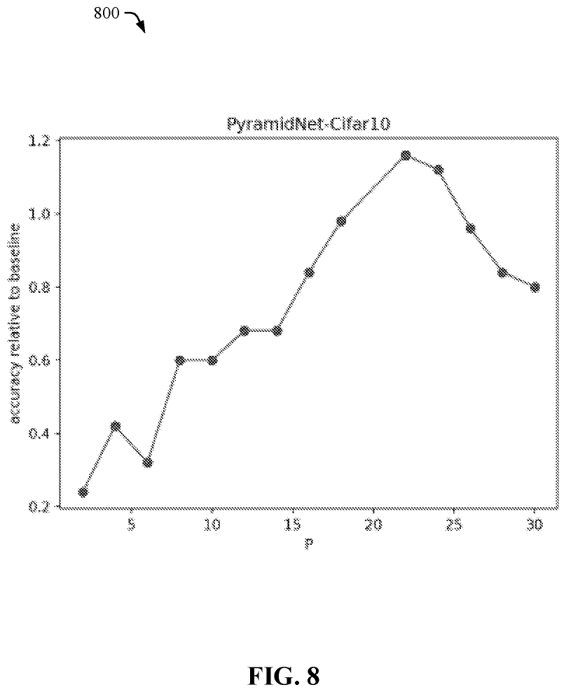

Additionally, FIG. 8 illustrate an example, non-limiting graphs 800 that can further verify the unimodality of one or more machine learning models 126 in accordance with one or more embodiments described herein. Repetitive description of like elements employed in other embodiments described herein is omitted for sake of brevity. To establish graph 800 the parameter definitions 404 generated by the parameter component 402 and exemplified in table 500 can be applied with Pₘₐₓ=30, then the relative performance was plotted against the global augmentation parameter P. With regards to graph 800, the data augmentation component 110 executed the RUA algorithm with the example pool of augmentation operations 128 and parameter definitions 404 shown in FIG. 5 to train the machine learning model 126 PyramidNet on the training dataset 124 Cifar10. Graph 800 verifies the unimodality relation and illustrates that despite minor randomness on the local scale, the overall unimodal relation between accuracy and the global augmentation parameter P can persist with the functions of the global parameter component 114 and the parameter component 402. In various embodiments, the data augmentation component 110 can generate similar graphs for a given machine learning model 126 and/or training dataset 124 to verify unimodality.

Based on the unimodal property of the one or more machine learning models 126, the search component 602 can employ one or more search algorithms that can leverage unimodal functions. For instance, the search component 602 can execute a golden-section search algorithm, which can find the maximum and/or minimum of a unimodal function over a given interval. Other example search algorithms that can be employed by the search component 602 can include, but are not limited to: binary search, tree search, interpolation search, a combination thereof, and/or the like. By employing the one or more search algorithms (e.g., via search component 602) on the reduced search space (e.g., generated by the functions of the global parameter component 114) with optimized parameter definitions 404 (e.g., via parameter component 402), the data augmentation component 110 can explore the search place without a grid search direct by human expertise (e.g., as necessitated by typical augmentation policies) and with few training iterations.

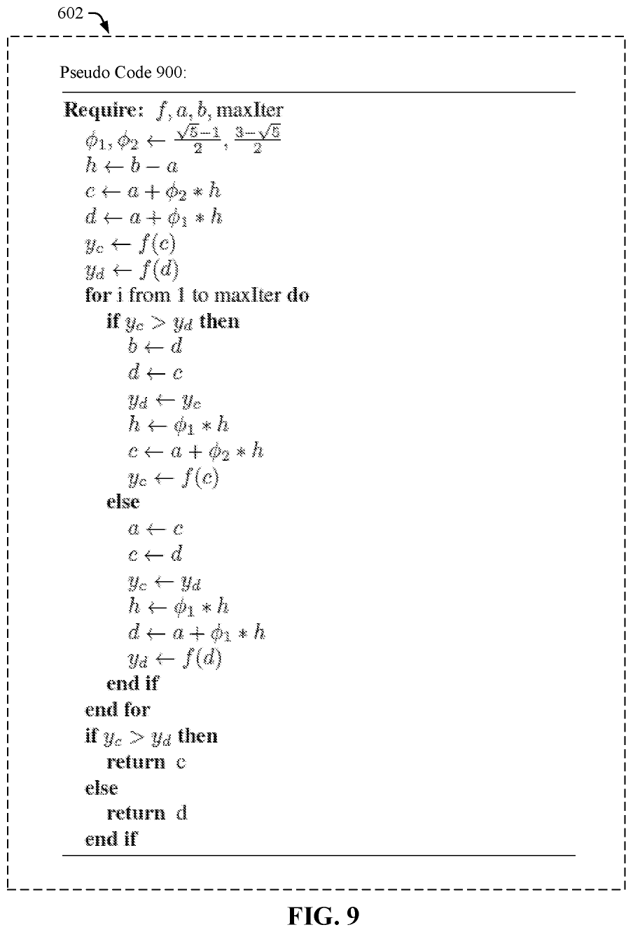

FIG. 9 illustrates a diagram of an example, non-limiting pseudo code 900 for a golden section search algorithm that can be employed by the search component 602 in accordance with one or more embodiments described herein. Repetitive description of like elements employed in other embodiments described herein is omitted for sake of brevity. As shown in FIG. 9, “f” can represent the function to be evaluated, “a” can represent the lower limit of the search space, “b” can represent the upper limit of the search space, “maxIter” can represent the maximum number of iterations to run the search, and the return value can be the domain value corresponding to the maximum evaluation of “f”. With the golden-section search algorithm characterized by pseudo code 900, each evaluation of the search space can reduce the remaining search space by a constant factor of about 0.618 (e.g., the inverse of the golden ratio). As a result, the data augmentation component 110 can solve for an integer value of P after 6 to 7 evaluations from an initial search space of size 30. In other words, the data augmentation component 110 can repeat the training task 6-7 times to find the best global augmentation parameter P.

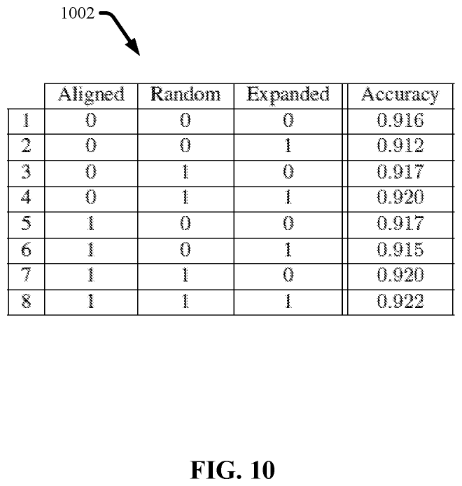

FIG. 10 illustrates a diagram of an example, non-limiting table 1002 that can further demonstrate the efficacy of the data augmentation component 110 in accordance with one or more embodiments described herein. Repetitive description of like elements employed in other embodiments described herein is omitted for sake of brevity. For example, table 1002 can be established from an ablation study of parameter definitions 404 that can be generated by the parameter component 402 and exemplified in table 500. In particular, a ResNet9 machine learning model 126 was trained on the Cifar10 training dataset 124, with accuracies averaged over 10 independent runs.

As described herein, the parameter component 402 can: generate parameter definitions 404 that have an impact positively correlated with P, can employ random uniform distribution, and can expand one or more augmentation parameters. Table 1002 depicts 8 rows, each corresponding to a respective combination of the parameter component's 402 possible functions (e.g., “aligned”, “random”, “expanded”) in generating the parameter definitions 404, where “0” indicates that the function was not employed and “1” indicates that the function was employed. For instance, the “aligned” column can indicate whether the parameter component 402 generated the parameter definitions 404 such that the augmentation operations directly correlate with the global augmentation parameter P (e.g., an increase in the value of the global augmentation parameter P translates to an increase in the amount of augmentation achieved by the augmentation operation). The “random” column can indicate whether the parameter component 402 generated the parameter definitions 404 with random uniform distribution. The “expanded” column can indicate whether the parameter component 402 expanded one or more parameter ranges in generating the parameter definitions 404 (e.g., as compared to typical augmentation implementations), as exemplified in at least the rotate augmentation operation shown in FIG. 5.

As shown in FIG. 10, row 1 of table 1002 can be analogous to an embodiment in which the RandAugment augmentation operations and definitions (e.g., defined in table 500) are implemented in conjunction with the golden-section search algorithm (e.g., where Pₘₐₓ=30). Row 8 can characterize an embodiment in which the parameter component 402 employed all three functions in generating the parameter definitions 404 (e.g., as exemplified in table 500) in conjunction with the golden-section search algorithm (e.g., where Pₘₐₓ=30). Rows 2-7 can characterize embodiments in which the parameter definitions 404 are generated with various combinations of the three functions of the parameter component 402.

As shown in table 1002, correcting the alignment of the “*” labelled augmentations from table 500 such that their impact is positively correlated with P can be beneficial; as evidenced by a comparison of rows: 1 vs. 5, 2 vs. 6, 3 vs. 7, and 4 vs. 8. Additionally, employing the random uniform distribution in generating the parameter definitions 404 can also be beneficial; as evidenced by a comparison of rows: 1 vs. 3, 2 vs. 4, 5 vs. 7, and 6 vs. 8. Moreover, increasing the maximum strength of augmentations (e.g., employing a value for the rotate augmentation operation of ±90 rather than ±30) can be deleterious on its own, but advantageous when paired with random sampling (e.g., as evidenced by a comparison of rows 3 vs. 4 and/or 7 vs. 8).

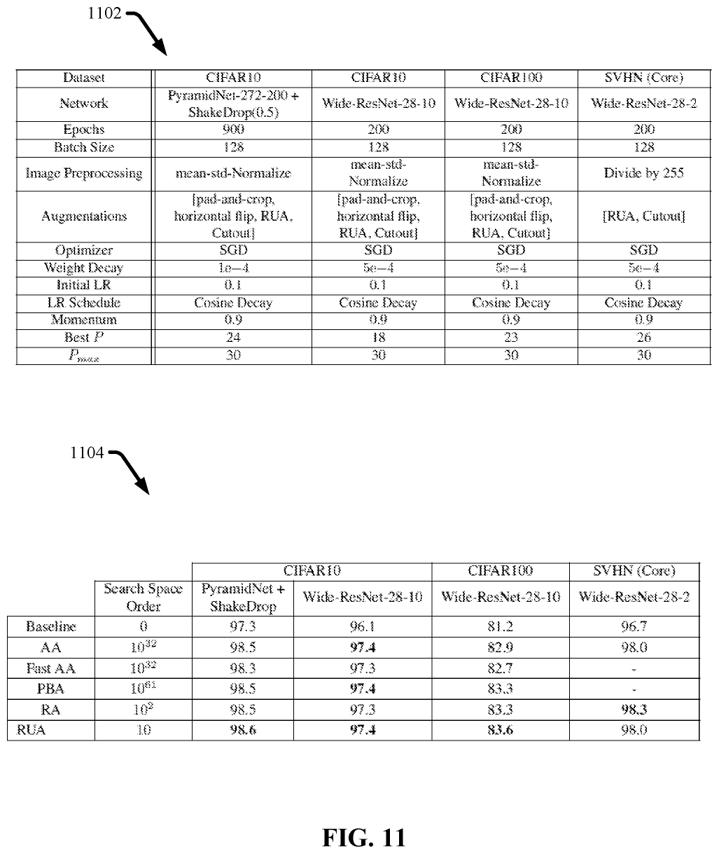

FIG. 11 illustrates a diagram of example, non-limiting tables 1102 and/or 1104 to further demonstrate the efficacy of the data augmentation component 110 in relation to typical augmentation policies in accordance with one or more embodiments described herein. Repetitive description of like elements employed in other embodiments described herein is omitted for sake of brevity. Table 1102 depicts the experiment parameter details associated with implementing the data augmentation component 110 to train the following publicly available machine learning model 126 networks: PyramidNet-272-200, ShakeDrop(0.5), Wide-ResNet-28-10, Wide-ResNet-28-10, Wide-ResNew-28-2. Additionally, as show in table 1102, the following publicly available training datasets 124 were utilized: Cifar10, Cifar100, and SVHN. As shown in table 1102 mean and/or standard deviation data normalization (“mean-std-Normalize”) can be utilized. Also, additional augmentation algorithms (e.g., “pad-and-crop,” “horizontal flip,” and/or “cutout”) can be utilized prior to, and/or subsequent to, execution of the RUA algorithm. Further, a stochastic gradient decent (“SGD”) optimizer can be utilized. Additionally, “LR” in table 1102 can represent learning rate. In each training dataset 124, five thousand training samples were held out as evaluation data for selecting the best parameter P. After selecting P, the hold-out set was incorporated back into the training dataset 124 and the machine learning model 126 was trained again. The test performance at the end of the final training iteration was then recorded.

Table 1104 depicts the final test results of the RUA algorithm performed by the data augmentation component 110 in comparison with the typical augmentation policies (e.g., RandAugment “RA”, AutoAugment “AA”, FastAutoAugment “FastAA”, and/or population based augmentation “PBA”), where the performance scores are from an average of 10 independent runs. The best accuracies from each column of table 1104 are highlighted in bold in FIG. 11. As demonstrated in table 1104, the RUA performed by the data augmentation component 110 achieved equal or better test scores that typical augmentation policies on 3 out of 4 tasks, while reducing the search space by an order of magnitude. For each of the 3 tasks, the improvement over the runner-up augmentation policy is statistically significant with one-tailed t-test p-values of 0.003, 0.001, and 0.011. With regards to dataset SVHN, the RUA algorithm, as executed by the data augmentation component 110, achieved competitive performance.

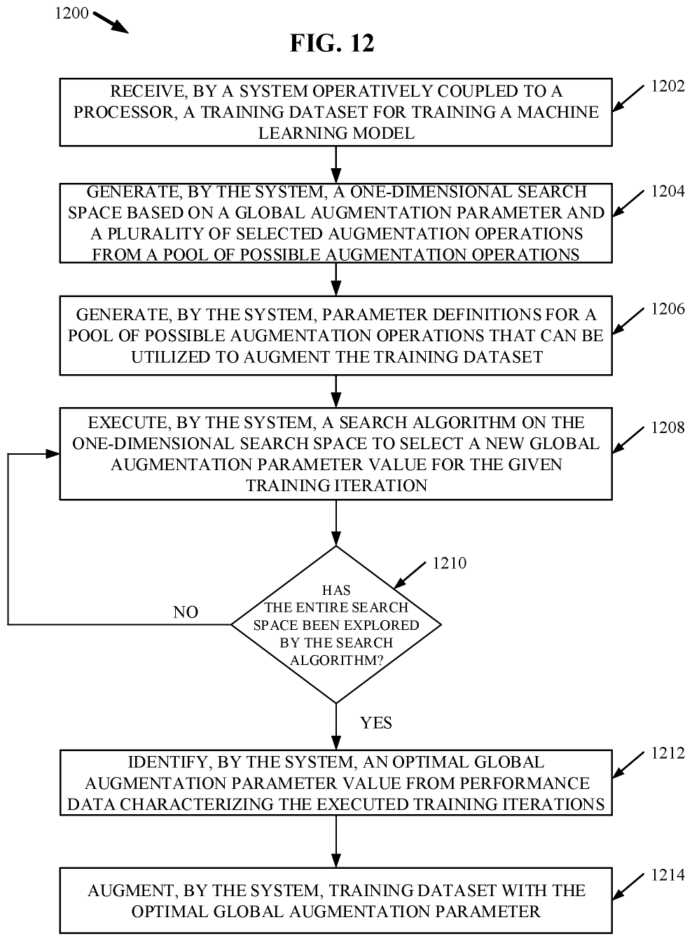

FIG. 12 illustrates a flow diagram of an example, non-limiting computer-implemented method 1200 that can facilitate augmenting one or more training datasets 124 with one or more RUA algorithms in accordance with one or more embodiments described herein. Repetitive description of like elements employed in other embodiments described herein is omitted for sake of brevity. While FIG. 12 illustrates an exemplary order of events, various features of the computer-implemented method 1200 can be performed in an alternate order.

At 1202, the computer-implemented method 1200 can comprise receiving (e.g., via communications component 112), by a system 100 operatively coupled to a processor 120, one or more training datasets 124. In various embodiments, the one or more training datasets 124 can be utilized to train one or more machine learning models 126. In accordance with various embodiments described herein, one or more settings 122 and/or machine learning models 126 can also be received at 1202. Additionally, one or more user preferences, such as preferred augmentation operations and/or parameter settings, can be included in the data received at 1202.

At 1204, the computer-implemented method 1200 can comprise generating (e.g., via global parameter component 114), by the system, a one-dimensional search space based on a global augmentation parameter P and/or a plurality of augmentation operations selected from a pool of possible augmentation operations 128. In accordance with various embodiments described herein, generating the one-dimensional search space can include defining the global augmentation parameter P. For example, the global augmentation parameter P can be defined as encompassing multiple parameters associated with the augmentation operations. For instance, the global augmentation parameter P can characterize both a distortion magnitude and a number of transformations associated with augmenting the training dataset. In various embodiments, the computer-implemented method 1300 can utilize a single global augmentation parameter to control augmentation of the one or more training datasets 124.

At 1206, the computer-implemented method 1200 can comprise generating (e.g., via parameter component 402, by the system 100, parameter definitions 404 for the pool of possible augmentation operations 128. In accordance with various embodiments described herein, the parameter definitions 404 can be generated to: be directly correlated with the global augmentation parameter P, incorporate a random uniform distribution, and/or expand one or more given parameter ranges. For instance, table 500 exemplifies a plurality of parameter definitions 404 that can be generated in association with 14 exemplary augmentation operations.

At 1208, the computer-implemented method 1300 can comprise executing (e.g., via search component 702), by the system 100, one or more search algorithms on the one-dimensional search space to select a new global augmentation parameter P value for the given training iteration. For example, the search algorithm executed at 1208 can leverage a unimodality relation exhibited by the machine learning model 126 to be trained. For instance, the search algorithm can be a golden-section search algorithm (e.g., as exemplified in FIG. 9). In various embodiments, the computer-implemented method 1200 can execute the search algorithm over multiple training iterations. For example, at 1210 the computer-implemented method 1200 can comprise determining (e.g., via data augmentation component 110) whether the entire search space has been explored by the search algorithm. Where the entire search space has not been explored, the computer-implemented method 1200 can proceed back to 1208. Where the entire search space has been explored, the computer-implemented method 1200 can proceed to 1212. In one or more embodiments, the determination at 1210 can be made in reference to a defined exploration threshold (e.g., defined via the one or more input devices 106) rather that in reference to the entirety of the search space.

At 1212, the computer-implemented method 1200 can comprise identifying (e.g., via search component 602), by the system 100, an optimal global augmentation parameter P value from performance data characterizing the executed training iterations. For instance, performance data regarding the machine learning model 126 can be collected in association with each new global augmentation parameter P value selected at 1208. Based on the performance data of all the global augmentation parameter P values selected via execution of 1208 one or more times, the optimal global augmentation parameter P value can be identified.

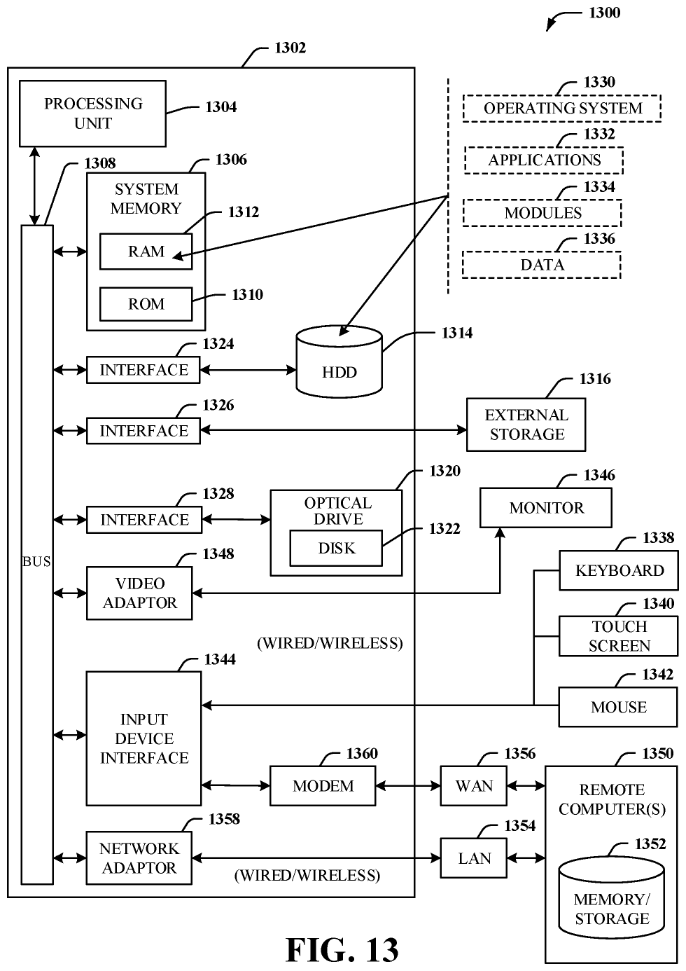

In order to provide additional context for various embodiments described herein, FIG. 13 and the following discussion are intended to provide a general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, and/or the like, that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (“IoT”) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (“RAM”), read only memory (“ROM”), electrically erasable programmable read only memory (“EEPROM”), flash memory or other memory technology, compact disk read only memory (“CD-ROM”), digital versatile disk (“DVD”), Blu-ray disc (“BD”) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (“BIOS”) can be stored in a non-volatile memory such as ROM, erasable programmable read only memory (“EPROM”), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (“HDD”) 1314 (e.g., EIDE, SATA), one or more external storage devices 1316 (e.g., a magnetic floppy disk drive (“FDD”) 1316, a memory stick or flash drive reader, a memory card reader, a combination thereof, and/or the like) and an optical disk drive 1320 (e.g., which can read or write from a disk 1322, such as: a CD-ROM disc, a DVD, a BD, and/or the like). While the internal HDD 1314 is illustrated as located within the computer 1302, the internal HDD 1314 can also be configured for external use in a suitable chassis (not shown). Additionally, while not shown in environment 1300, a solid state drive (“SSD”) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (“USB”) and Institute of Electrical and Electronics Engineers (“IEEE”) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (“VM”) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enable with a security module, such as a trusted processing module (“TPM”). For instance with a TPM, boot components hash next in time boot components, and wait for a match of results to secured values, before loading a next boot component. This process can take place at any layer in the code execution stack of computer 1302, e.g., applied at the application execution level or at the operating system (“OS”) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (“IR”) remote control, a radio frequency (“RF”) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, and/or the like.

A monitor 1346 or other type of display device can be also connected to the system bus 1308 via an interface, such as a video adapter 1348. In addition to the monitor 1346, a computer typically includes other peripheral output devices (not shown), such as speakers, printers, a combination thereof, and/or the like.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (“LAN”) 1354 and/or larger networks, e.g., a wide area network (“WAN”) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (“AP”) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wireles sly detectable tag (e.g., a kiosk, news stand, store shelf, and/or the like), and telephone. This can include Wireless Fidelity (“Wi-Fi”) and BLUETOOTH® wireless technologies. Thus, the communication can be a predefined structure as with a conventional network or simply an ad hoc communication between at least two devices.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer-executable components; and
a processor, operably coupled to the memory, that executes the computer-executable components stored in the memory, wherein the computer-executable components comprise:
a data augmentation component that executes a random unidimensional augmentation algorithm to augment a dataset for training a machine learning model via a plurality of augmentation operations, wherein the random unidimensional augmentation algorithm employs a global augmentation parameter that defines: a distortion magnitude associated with the plurality of augmentation operations, and a number of augmentation operations included in the plurality of augmentation operations.

2. The system of claim 1, wherein the data augmentation component randomly selects the plurality of augmentation operations from a pool of possible augmentation operations with uniform probability, and wherein the distortion magnitude controls an amount of augmentation associated with augmentation operations from the plurality of augmentation operations.

3. The system of claim 2, further comprising:
a global parameter component that generates a one-dimensional search space based on the global augmentation parameter and plurality of augmentation operations selected.

4. The system of claim 3, further comprising:
a parameter component that generates parameter definitions for the pool of possible augmentation operations, wherein the parameter definitions align the possible augmentation operations with the global augmentation parameter such that the amount of augmentation directly correlates with the global augmentation parameter.

5. The system of claim 4, wherein the parameter component controls a density of the one-dimensional search space by introducing a random uniform distribution into the parameter definitions.

6. The system of claim 5, further comprising:
a search component that executes a search algorithm on the one-dimensional search space based on the global augmentation parameter to execute an automated search space reduction.

7. The system of claim 6, wherein the search algorithm executes the automated search space reduction based on a unimodal function that characterizes a performance metric of the machine learning model.

8. A computer-implemented method, comprising:
executing, by a system operably coupled to a processor, a random unidimensional augmentation algorithm to augment a dataset for training a machine learning model via a plurality of augmentation operations, wherein the random unidimensional augmentation algorithm employs a global augmentation parameter that defines: a distortion magnitude associated with the plurality of augmentation operations, and a number of augmentation operations included in the plurality of augmentation operations.

9. The computer-implemented method of claim 8, wherein the random unidimensional augmentation algorithm randomly selects the plurality of augmentation operations from a pool of possible augmentation operations with uniform probability, and wherein the distortion magnitude controls an amount of augmentation associated with augmentation operations from the plurality of augmentation operations.

10. The computer-implemented method of claim 9, further comprising:
generating, by the system, a one-dimensional search space based on the global augmentation parameter and plurality of augmentation operations selected.

11. The computer-implemented method of claim 10, further comprising:
generating, by the system, parameter definitions for the pool of possible augmentation operations, wherein the parameter definitions align the possible augmentation operations with the global augmentation parameter such that the amount of augmentation directly correlates with the global augmentation parameter.

12. The computer-implemented method of claim 11, wherein the generating the parameter definitions control a density of the one-dimensional search space by introducing a random uniform distribution into the parameter definitions.

13. The computer-implemented method of claim 12, further comprising:
executing, by the system, a search algorithm on the one-dimensional search space based on the global augmentation parameter to execute an automated search space reduction.

14. The computer-implemented method of claim 13, wherein the search algorithm executes the automated search space reduction based on a unimodal function that characterizes a performance metric of the machine learning model.

15. A computer program product for a data augmentation process, the computer program product comprising a computer readable storage medium having program instructions embodied therewith, the program instructions executable by a processor to cause the processor to:
execute, by the processor, a random unidimensional augmentation algorithm to augment a dataset for training a machine learning model via a plurality of augmentation operations, wherein the random unidimensional augmentation algorithm employs a global augmentation parameter that defines: a distortion magnitude associated with the plurality of augmentation operations, and a number of augmentation operations included in the plurality of augmentation operations.

16. The computer program product of claim 15, wherein the random unidimensional augmentation algorithm randomly selects the plurality of augmentation operations from a pool of possible augmentation operations with uniform probability, and wherein the distortion magnitude controls an amount of augmentation associated with augmentation operations from the plurality of augmentation operations.

17. The computer program product of claim 16, wherein the program instructions further cause the processor to:
generate, by the processor, a one-dimensional search space based on the global augmentation parameter and plurality of augmentation operations selected.

18. The computer program product of claim 17, wherein the program instructions further cause the processor to:
generate, by the processor, parameter definitions for the pool of possible augmentation operations, wherein the parameter definitions align the possible augmentation operations with the global augmentation parameter such that the amount of augmentation directly correlates with the global augmentation parameter.

19. The computer program product of claim 18, wherein a density of the one-dimensional search space is controlled by introducing a random uniform distribution into the parameter definitions.

20. The computer program product of claim 19, wherein the program instructions further cause the processor to:
execute, by the processor, a search algorithm on the one-dimensional search space based on the global augmentation parameter to execute an automated search space reduction, wherein the search algorithm executes the automated search space reduction based on a unimodal function that characterizes a performance metric of the machine learning model.
